(19) United States
(12) Patent Application Publication
(10) Pub. No.: US 2025/0104026 A1
(43) Pub. Date: Mar. 27, 2025

(54) TRACKING STAKED TOKEN RETURNS

(71) Applicant: Coinbase, Inc., Oakland, CA (US)

(72) Inventor: Madalina Chiru, London (GB)

(21) Appl. No.: 18/372,050

(22) Filed: Sep. 22, 2023

(51) Int. Cl. G06Q 20/06; G06Q 20/38

(52) U.S. Cl. CPC G06Q 20/065; G06Q 20/381; G06Q 2220/00

(57) ABSTRACT

Methods, systems, and devices for tracking staked token returns are described. A custodial token platform receives a request to wrap an initial first amount of a first crypto token that is staked. The custodial token platform wraps the first amount of the first crypto token, resulting in a wrapped amount of a second crypto token. The custodial token platform detects a first trigger event while the user is associated with at least one prior principal amount and a prior return amount of the second crypto token. The custodial token platform determines an additional return amount. Determining involves calculating, using an updated conversion ratio, a first principal amount and a first return amount for the at least one prior principal amount, a second principal amount and a second return amount for the prior return amount, and combining the first return amount and the second return amount as the additional return amount.

### FIELD OF TECHNOLOGY

The present disclosure relates generally to data management, including techniques for tracking staked token returns.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports tracking staked token returns in accordance with aspects of the present disclosure.

FIG. 2 shows an example of a computing environment that supports tracking staked token returns in accordance with aspects of the present disclosure.

FIG. 3 shows an example of a tracking structure of a tracking technique that supports tracking staked token returns in accordance with aspects of the present disclosure.

FIG. 4 shows an example of a process flow that supports tracking staked token returns in accordance with aspects of the present disclosure.

FIG. 5 shows a block diagram of an apparatus that supports tracking staked token returns in accordance with aspects of the present disclosure.

FIG. 6 shows a block diagram of a staked token tracker manager that supports tracking staked token returns in accordance with aspects of the present disclosure.

FIG. 7 shows a diagram of a system including a device that supports tracking staked token returns in accordance with aspects of the present disclosure.

FIGS. 8 through 10 show flowcharts illustrating methods that support tracking staked token returns in accordance with aspects of the present disclosure.

### DETAILED DESCRIPTION

A user may access a custodial token platform to purchase, sell, exchange, or trade digital assets, such as cryptocurrencies, crypto tokens, or the like. A custodial token platform may support various types of wallets for deposits, withdrawals, and storage. For example, the custodial token platform may generate inbound wallets associated with inbound addresses for user deposits of crypto tokens to accounts associated with the user. The custodial token platform may also use outbound wallets for supporting withdrawals of crypto tokens and cold storage wallets for security. In some cases, the custodial token platform may support a wallet orchestration procedure that moves the crypto tokens between the various wallets of the custodial token platform for various reasons including liquidity management and security. In some examples, users may stake crypto tokens via the custodial token platform. That is, the custodial token platform may provide a service that allows the user to receive crypto tokens via the corresponding blockchain network. Staking refers to the process by which the user may lock a crypto token for the network, allowing the user to participate in consensus, validating transactions, and to create blocks, in order to facilitate securing the network. In return, the user staking the crypto token (e.g., staking user) earns rewards, such as interest on the amount of crypto tokens staked. In some cases, the rewards may be the result of new issuance or net-new issuance of tokens by a blockchain protocol. In the cases of staking via the custodial token platform, the custodial token platform may perform these operations on behalf of the user and distribute the rewards to users that stake via the platform.

When the user stakes a crypto token via a blockchain network, the crypto token may become locked, which makes the crypto token non-transferable. In order to make the staked crypto token transferable, the staked crypto token may be converted to or exchanged for a wrapped staked crypto token. The wrapped staked crypto token may represent the underlying staked crypto token. The wrapped staked crypto token may also represent or be associated with the rewards earned for staking the crypto token. The wrapped staked crypto token may be fully transferable via the blockchain network. The staked crypto token may be converted to the wrapped staked crypto token based on a conversion rate or conversion ratio, which is the rate at which the wrapped token will be issued or redeemed relative to the amount of staked token being wrapped. The conversion ratio may be a function of the amount of the token staked, any post-commission rewards earned, any penalties imposed, and/or a total wrapped token supply, that may vary over time. Accordingly, the conversion ratio may vary or fluctuate over time, and the rewards earned on the staked crypto token may also vary or fluctuate based on the conversion ratio.

Tracking the amount of the wrapped staked crypto token, for example, to track the amount of staked crypto token and the rewards earned on the staked crypto token, may provide a holistic view of the value associated with crypto tokens of the staking user to facilitate transactions. Tracking the value of the wrapped staked crypto token may also provide an indication of income earned (e.g., rewards) that may be taxed. Since the conversion ratio may vary over time, tracking a present amount of wrapped staked crypto token, for example, as principal income and reward, may be difficult. For example, when the conversion rate changes, the wrapped staked crypto token may be divided into a principal income amount and a reward amount, as discussed herein. Each subsequent change in the conversion rate may further cause the prior principal income amount to be divided into another principal income amount and another reward amount, and each reward amount to be divided into another principal income amount and a reward amount. That is, the principal income amount and rewards amount may be compounded values and exponentially increase, and computing or tracking such values may be difficult or computationally expensive in terms of computing resources (e.g., processor and memory resources) of the custodial token platform.

Techniques described herein address these difficulties by providing a technique for tracking rewards distributions for a staked crypto token corresponding to a wrapped crypto token associated with a user account. For example, as rewards are distributed for a crypto token corresponding to the wrapped token, the platform may determine additional return amounts by calculating a first principal and a first return amount for a prior principal amount and a second principal and a second return amount for a prior return amount. The first return amount and the second return amount is associated with a user account as an additional return amount, which may be used as a prior return amount for subsequent rewards distributions. As such, rather than the principal and return amounts increasing exponentially with each distribution, these amounts may increase linearly, which may reduce computational complexity. These and other techniques are described in further detail with respect to the figures.

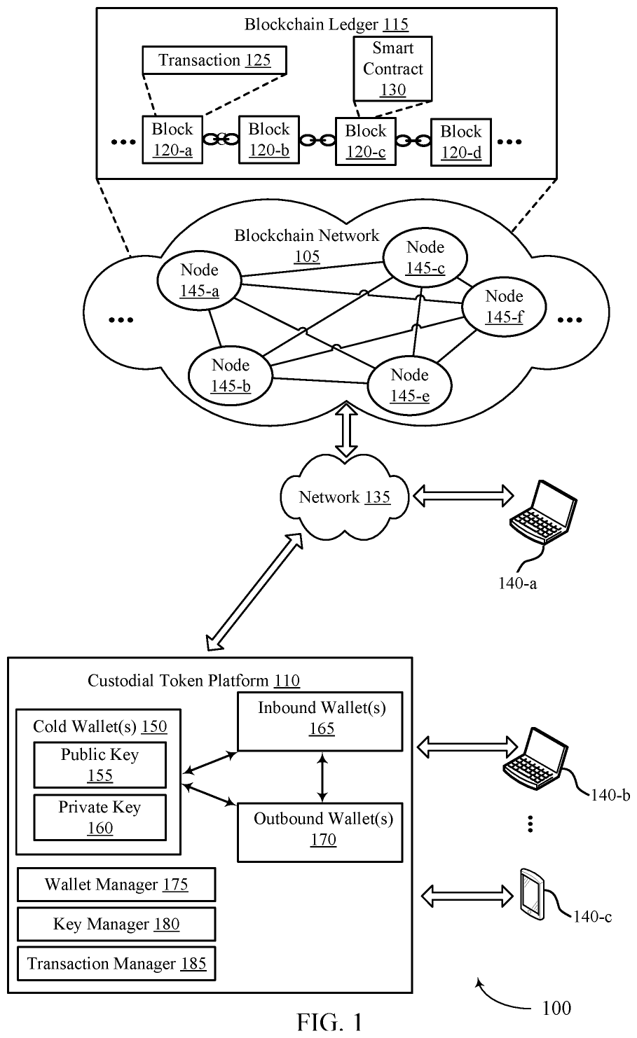

FIG. 1 illustrates an example of a computing environment 100 that supports tracking staked token returns in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to cause transfer of tokens from a wallet managed by the custodial token platform 110 to an external wallet, to deploy a smart contract (e.g., a self-executing program), or to call a smart contract.

Additionally, a user may access the custodial token platform 110 via a custodial application to purchase, sell, exchange, or trade digital assets, such as crypto tokens and the like, in a secure manner. Purchasing, selling, exchanging, or otherwise performing transactions in the custodial token platform 110 may involve staking tokens and wrapped staked crypto tokens. The wrapped staked crypto token may represent the underlying staked crypto token and the wrapped staked crypto token may be associated with rewards that are earned for staking the crypto token. The wrapped staked crypto token may be transferable via the blockchain network 105. The value of the wrapped staked crypto token may be based on the conversion ratio for converting staked crypto token to the wrapped staked crypto token, and the conversion ratio may vary over time. The reward amount earned on the staked crypto token may also vary or fluctuate based on the conversion ratio. In some examples, tracking the value or amount of the wrapped staked crypto token and the rewards earned on the staked crypto token may provide a holistic view of a portfolio value associated with the crypto tokens for the user, as well as provide an indication of income earned from the staked crypto tokens since the income earned as rewards may be taxed. A triggering event, such as a rewards distribution (e.g., caused by a change in the conversion ratio), may cause a prior principal income amount of the staked crypto token to be divided into another principal income amount and another reward amount, and each reward amount to be divided into another principal income amount and a reward amount. That is, the principal income amount and reward amount may have a compounding effect over time, and computing or tracking such compounding values in the blockchain network 105 may be difficult or computationally expensive for computing resources of the custodial token platform 110.

Techniques described herein address the foregoing by supporting a technique for efficiently tracking return/reward distributions corresponding to a wrapped token (e.g., a liquidity token) associated with a staked crypto token. For example, the custodial token platform 110 may receive a request from a user to wrap an initial first amount of a first crypto token that is staked in accordance with a protocol associated with a blockchain network 105 supported distributed data store. The custodial token platform 110 may wrap the first amount of the first crypto token (e.g., staked crypto token). Wrapping may result in a wrapped amount of a second crypto token (e.g., wrapped staked crypto token) being associated with the user. The custodial token platform 110 may detect a first trigger event while the user is associated with at least one prior principal amount and a prior return amount (e.g., rewards earned from staked crypto token) of the second crypto token as a result of a prior trigger event (e.g., change in conversion ratio causing a rewards distribution). The trigger event may include a return distribution for the first crypto token as a result of staking the first crypto token via the protocol. In some cases, the trigger event may include a change to the conversion ratio. The custodial token platform 110 may determine an additional return amount. To determine the additional return amount, the custodial token platform 110 may calculate, using an updated conversion ratio resulting from the return distribution, a first principal amount and a first return amount for the at least one prior principal amount. The custodial token platform 110 may calculate, using the updated conversion ratio, a second principal amount and a second return amount for the prior return amount. The custodial token platform 110 may combine the first return amount and the second return amount as the additional return amount, and associate the additional return amount, the first principal amount, and the second principal amount with the user. This technique of tracking the wrapped staked crypto token involving combining the return amounts may result in less computing resource overhead to efficiently track the staked crypto token and/or the rewards earned.

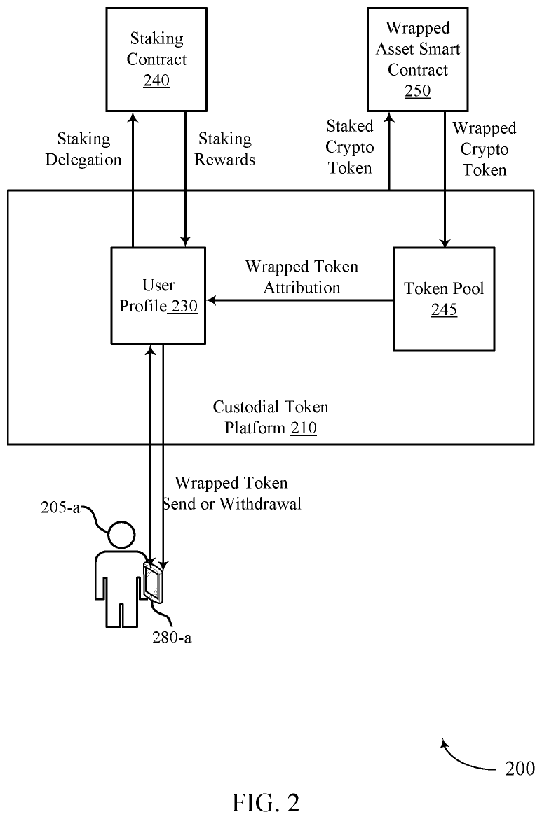

FIG. 2 shows an example of a computing environment 200 that supports tracking staked token returns in accordance with aspects of the present disclosure. The computing environment 200 includes a custodial token platform 210 and a user 205 with a respective user device 280. The custodial token platform 210 may be an example of the custodial token platform 110 as described with respect to FIG. 1, and the user device 280 may be an example of the computing devices 140 as described with respect to FIG. 1. Although the discussions described herein relate to cryptocurrency with respect to crypto tokens, the cryptocurrency may include tokens, coins, digital currency, and the like.

The custodial token platform 210 may store or access token-related data, as well as support various token-related transactions for various purposes. For example, the custodial token platform 210 may support a user profile 230 and a token pool 245. The user profile 230 may include data associated with the user 205 with respect to the custodial token platform 210. The data may include one or more user addresses (e.g., wallet addresses), current cryptocurrencies held by the user 205 (e.g., Ether (ETH), Ether2 (ETH2), cbETH.), staked cryptocurrencies, rewards associated with the staked cryptocurrencies, past transactions, pending transactions, requests to wrap or unwrap staked crypto currencies, and the like. The user profile 230 may also provide or be associated with an interface that facilitates transfer of crypto tokens within the custodial token platform 210, such as an interface for requesting wrapping of staked crypto token associated with the user 205, as well as transfer of crypto tokens externally via the corresponding blockchain network. In some cases, a user 205 may utilize the services described herein and request the wrapped token, which may result in sending a wrapped crypto token to the user profile 230. The user 205 may then request to unwrap the wrapped crypto token, which may result in the token being returned to the respective token pool (e.g., token pool 245). In some cases, the amount of staked crypto token, wrapped staked crypto token, and/or the rewards associated with the staked crypto token of the user 205 may be tracked.

In some examples, the custodial token platform 210 may allow users 205 to stake one or more types of crypto tokens according to a staking protocol associated with a respective blockchain network. As used herein, staking refers to a process in which users 205 may delegate or contribute their crypto tokens to the blockchain network to support the blockchain network. Staking may involve locking crypto tokens for a set period of time to support the operation of the blockchain network. Users 205 may be able to stake their crypto tokens from a non-custodial (e.g., self-custody) wallet, but the staking mechanism may be complex. As such, the custodial token platform 210 allows users 205 to stake via the custodial token platform 210, which improves user experience while also contributing to the security of the blockchain network. In response to requesting to stake via the custodial token platform 210, the custodial token platform 210 may broadcast a message to a staking contract 240, as well as deposit crypto tokens into the staking contract 240. In some cases, the staking contract 240 is an example of a smart-contract that manages staking-related transactions. For example, the staking contract 240) may be a self-executing program stored on a blockchain that executes when conditions are met, such as a condition of receiving a staking request. The staking contract 240 may be used by the custodial token platform 210 to perform staking related procedures for users 205 that stake via the custodial token platform 210. The staking contract 240 may execute and provide staking returns or rewards for the users 205 staking via the custodial token platform 210. The custodial token platform 210 may maintain an internal accounting of those users 205 that have staked via the custodial token platform 210, the amount of tokens staked by users 205, and the corresponding portion of rewards that should be associated with the users 205. An indication of the staking delegation, processes associated with the staking contract 240, or the amount of staking returns, may be indicated to the user 205 via the user interface of the custodial token platform 210. In particular, internal accounting of the users 205 that have staked via the custodial token platform 210, the amount of tokens staked by users 205, and the corresponding portion of rewards that should be associated with the users 205 may be tracked, for example, as a principal amount and a reward amount.

Staking may involve locking an amount of the crypto token for a lockup period. However, the custodial token platform 210 may support a liquid staking procedure which awards a user 205 with a liquidity token that represents a user's crypto tokens that are staked via the custodial token platform 210. The user 205 may trade via the custodial token platform 210 using the liquidity token or transact on the associated blockchain network via the liquidity token. Thus, the user 205 is effectively allowed to stake tokens and use an asset representing the staked token for other purposes. The liquidity token may be referred to as a “wrapped” token, as the token may represent the underlying staked token and may be issued by a smart contract.

The conversion ratio for converting the staked crypto token to the wrapped token (e.g., 10 ETH for 8 cbETH) may vary over time. Accordingly, the value of the wrapped staked crypto token associated with the user 205 may also vary and may be tracked. Tracking the value of the wrapped staked crypto token and the rewards earned on the staked crypto token may provide a holistic view of the value associated with the crypto token, as well as provide an indication of reward earned that may be taxed. Since the conversion ratio may vary over time, tracking the present value of the wrapped staked crypto token and/or the rewards may be difficult. For example, when a trigger event occurs (e.g., rewards distribution due to a change in conversion ratio), the wrapped staked crypto token may be divided into a principal income amount and a rewards amount, as discussed herein. Each subsequent change in the conversion ratio may further cause the prior principal income amount to be divided into another principal income amount and another reward amount, and each reward amount to be divided into another principal income amount and a reward amount.

Additionally, techniques described herein allow tracking each occurrence of the principal income amount and the reward amount. For example, at each occurrence of the triggering event, multiple amounts of rewards may be combined. Combining the multiple rewards may facilitate efficiently tracking the single combined amount of rewards as multiple rewards are generated for the multiple principal amounts after the occurrence of multiple triggering events.

In some cases, to support these techniques, the custodial token platform may deploy liquidity contract 250 to the blockchain network. The liquidity contract 250 may be used for minting the wrapped token that represents the staked token. Thus, when a user 205 requests staking or requests the wrapped token representing their tokens staked via the custodial token platform 210, the custodial token platform 210 may transact with the liquidity contract 250) to mint new tokens representing the user's staked tokens.

Additionally, to support the multitude of users 205 accessing the custodial token platform 210, the custodial token platform 210 may implement a premint procedure to premint a pool of wrapped tokens and allow for instant liquidity for users 205 of the custodial token platform 210. After deploying the liquidity contract 250, the custodial token platform 210 may premint a pool of wrapped tokens and store the wrapped tokens to the token pool 245. The wrapped staked crypto token described herein may be based on a cToken model, but it should be understood that some of the techniques described herein are applicable to other token models, such as aTokens. According to the cToken model, the wrapped tokens represent ownership of the underlying principal (e.g., the staked token) plus any rewards accrued on that principal, minus penalties (if any). Thus, the conversion ratio between the wrapped token and the underlying assets (principals+rewards−penalties) changes as a function of the rewards and penalties impacting the principal. As an example, Bob supplies 10 ETH to the custodial token platform 210 and receives 10 cbETH (e.g., wrapped token). After some time passes, Bob earns 2 ETH of rewards on his account. Bob's cbETH position remains at 10 cbETH (no change in supply held), but the position is now backed by 12 ETH, which changes the conversion rate of cbETH relative to ETH. Bob then removes his liquidity from the protocol, converting his 10 cbETH for 12 ETH. Thus, structured as a cToken, the wrapped staked crypto token has rights to the underlying staked token and the accrued rewards and penalties. Changes in these underlying amounts have impacts on the conversion rate between the wrapped staked crypto token and the staked crypto token.

The conversion ratio (e.g., conversion rate) is the rate at which the wrapped staked crypto token will be issued or redeemed relative to the amount of staked crypto token being wrapped. The conversion ratio is a function of the amount of the token staked, any post-commission rewards earned, any penalties imposed, and a total wrapped token supply. The conversion rate may be pulled from both the smart contract (e.g., the liquidity contract 250) and an application programming interface (API) associated with the custodial token platform 210 (where the custodial token platform 210 informs the smart contract of the conversion rate). At first mint (e.g., premint), a 1:1 ratio between the staked crypto token and the wrapped crypto token may be established. Thus, at a high level, the conversion ratio at the total pool level (e.g., the token pool 245) is calculated as follows:

$$conversion rate = \frac{Total Underlying Wrapped Staked Token}{Total Wrapped Token Supply} ,$$

where Total Underlying Wrapped Staked Token=the staked token settled in wraps (e.g., contributed to the liquidity contract 250)−Staked token settled in unwrap+Net rewards. Total Wrapped Token Supply=wrapped token issued−wrapped token redeemed. Net rewards=inflationary protocol rewards+Transaction fees (tips) & other validator rewards−Penalties)−fees. In some cases, the custodial token platform 210 may obtain a fee (e.g., 25% fee) of the rewards.

Thus, the custodial token platform 210 may periodically assess an amount of eligible tokens staked on the custodial token platform 210 and may mint a corresponding amount of the wrapped token using the liquidity contract 250 in accordance with the current conversion rate. The wrapped staked crypto token is minted on-chain to the designated receiver wallet. The wrapped staked crypto token supplies may be updated based on the underlying staked crypto token at a configured cadence (e.g., 4 hours, 3 days, and so forth).

As described herein, the conversion ratio may be dependent on penalties incurred via the underlying blockchain network. In the example of Ethereum, the consensus mechanism has several rules to protect the integrity of the network. If any of these rules are broken (voluntarily or not), a portion of staked ETH may be slashed. Some examples include validator downtime and double-signing.

In some examples, the user 205 having wrapped staked crypto token may not receive reward in the actual increase of the wrapped staked crypto token balance. Rather, the reward is tracked as an increase in the conversion rate, which may be materialized by unwrapping the wrapped staked crypto token back into the staked crypto token. By unwrapping the same amount or originally wrapped amount of the wrapped staked crypto token after a reward distribution (e.g., a change in the conversion rate), the conversion may provide a relatively larger quantity of the staked crypto token than the original amount of the staked crypto token.

In some cases, the rewards earned by staking may be considered income, which may be taxable. The presently held staking rewards may be taxed as income, for example, at the market value and date (e.g., withdrawal date or upgrade date) of the first withdrawal occurring on the blockchain platform. In some cases, future staking rewards may be taxed as income at the market value and date that the rewards are received.

Wrapped staked crypto tokens may be intended to be taxed similarly or correspondingly to the staked crypto token. Accordingly, when an occurrence of an income lot is generated for staking rewards for the staked crypto token (e.g., ETH), a corresponding income lot may be generated for the wrapped staked crypto token holding staking rewards (e.g., rewards income lot for cbETH).

That is, staked crypto token rewards may be taxable as income using values of when the rewards are received, increases in conversion ratio may be tracked as income at the same cadence as the staked crypto token rewards distribution, and gain and loss calculations on wrapped staked crypto tokens may be the same as if the user 205 was taxed on the staked crypto token. As such, the income cost basis may be considered when calculating realized gains and losses.

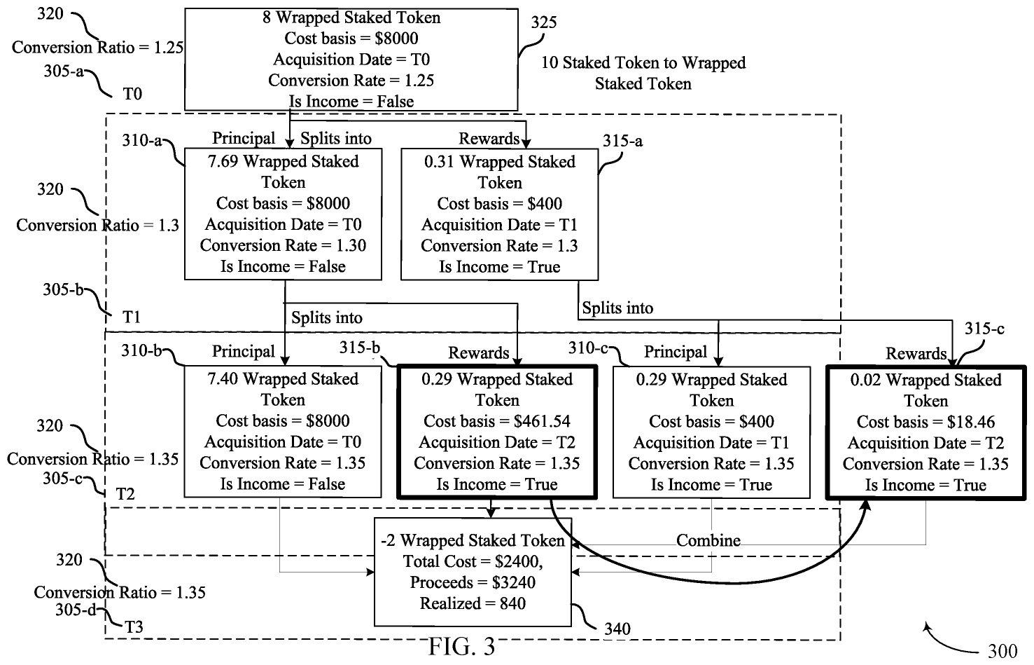

For unwrapped or un-liquidated or unwrapped staked crypto tokens, the staking rewards may be indicated as income using the values available at the date of acquisition at the custodial token platform 210. For example, and as discussed with respect to FIG. 3, a staking reward may be received or acquired on a first date, TO (e.g., initial time period) and may be associated with a market price, P0 on T0. The staking reward may be liquidated (e.g., withdrawn) on a second date, T1 (e.g., second time period) when the market price has changed to a second market price, P1. The staking reward may be associated with income based on the date of receipt or acquisition of the reward (T0 associated with P0) rather than the date of liquidation (T1 associated with P1). For the un-liquidated wrapped staked crypto token lots, the change (e.g., increase) in the conversion rate may be tracked, and the amount may be indicated as income using data from each conversion rate changing event (e.g., trigger event) occurring at the custodial token platform 210. As staking rewards correspond to changes in conversion rates, as described herein, the income is taken at the market price on the date of the conversion rate change. Future staking rewards may be taxed as income at the market price and date when they are received.

Additionally, the income may also be calculated due to a different triggering event, such as a protocol upgrade (e.g., the Ethereum Protocol). For example, prior to a protocol upgrade, the staked ETH could not be liquidated, and as such, it would have been unfair to tax something that cannot be converted to a fiat currency. After the upgrade that allowed staked ETH to be liquidated, the ETH staking rewards that the users held would be taxed as income at the market value and the date of the upgrade. However, instead of using the date of the upgrade, the custodial token platform 210 may use the date and values of the first withdrawal that occurs on the custodial token platform 210.

Accordingly, to calculate the income, the income amount=(the amount of wrapped staked crypto token)*(the conversion rate on the date of the withdrawal−the conversion rate at acquisition)*(the crypto token market price on the day of the withdrawal). As discussed herein, the principal income amount and rewards amount associated with the wrapped staked crypto token may be compounded values, and these values may be tracked for combining and otherwise efficiently processing at computing resources of the custodial token platform 210. Since the staking crypto token is compounding, each reward distribution may produce another reward in the future. Although the following descriptions discuss wrapped staked crypto tokens, the techniques described herein may apply to any wrapped future assets associated with the custodial token platform 210.

FIG. 3 shows an example of a tracking structure 300 of a tracking technique that supports tracking staked token returns in accordance with aspects of the present disclosure. The reward distribution (e.g., return distribution) may be in the form of an increase in conversion ratio rather than an increase in balance of the wrapped staked crypto token. For example, a percentage of an original balance of the wrapped staked crypto token may be unwrapped using a new conversion rate (e.g., the increased conversion rate), and the unwrapping may result in a reward amount (e.g., return amount) while the rest of the original balance may become categorized as a principal income amount.

To illustrate, at an initial time period 305-a (T0), staked crypto tokens may be wrapped into wrapped staked crypto tokens. For example, the conversion ratio 320 may be equal to 1.25, such that 1.25 staked crypto tokens may provide or be equal to 1 wrapped staked crypto token after wrapping. At the initial time period 305-a, 10 staked crypto tokens may be wrapped to provide an original balance 325 of 8 wrapped staked crypto tokens. In some examples, the cost for this transaction may be $8000 (e.g., cost basis=$8,000, which is based on the quantity of wrapped staked crypto token and a cost price) and the original balance 325 may not be considered income (e.g., is income=false) since rewards have not yet been distributed.

However, at a second time period 305-b (T1), the conversion ratio 320 may change from 1.25 to 1.3 (as a result of a rewards distribution), such that 1.3 staked crypto tokens may provide 1 wrapped staked crypto tokens after wrapping. The change to the conversion rate may result in a return distribution (e.g., rewards distribution), and the change to the conversion ratio and/or the return distribution may be a triggering event. The triggering event may result in a balance of wrapped staked crypto tokens to be divided or split into a principal income amount and a reward amount (e.g., return amount), which may be categorized as income. In some examples, the income may be taxed for the user. Also, as discussed herein, the return distribution may indicate the gain as the return amount (e.g., reward amount) when converting the staked crypto token to wrapped staked crypto token using the new conversion ratio as compared to the present balance of the wrapped staked crypto token.

To illustrate, the original balance 325 is split into a first principal income amount 310-a and a first reward amount 315-a as a return distribution (e.g., rewards distribution). As such, the triggering event may include a return distribution as a result of staking the crypto token (e.g., the 10 staked crypto tokens). Since the conversion ratio 320 changed to 1.3, the 10 staked crypto tokens (from acquisition date of T0) may now provide 7.69 wrapped staked crypto tokens but the original balance 325 at the initial time period 305-a is 8 wrapped staked crypto tokens, so there has been a 0.31 gain in wrapped staked crypto tokens for the user. Accordingly, the first reward amount 315-a is a rewards distribution of 0.31 of wrapped staked crypto tokens for the 10 staked crypto tokens at the second time period 305-b (from acquisition date of T1). In some examples, the cost for this reward may be $400 (e.g., cost basis=$400, which is based on the quantity of wrapped staked crypto token and a cost price) and the first reward amount 315-a may be considered income (e.g., is income=true) since it is a gain. The user may benefit from tracking return distributions for tax purposes, as well as for a holistic understanding of the user's portfolio balance. The cost basis for the first principal income amount 310-a is still $8000 based on the acquisition date of T0, and thus, is not income (e.g., is income=false).

At a third time period 305-c (T2), the conversion rate may change from 1.3 to 1.35, resulting in the first principal income amount 310-a to be split into a second principal income amount 310-b and a second reward amount 315-b, and the first reward amount 315-a may be split into a third principal income amount 310-c and a third reward amount 315-c based on the principal income and reward amount discussed with respect to the second time period 305-b (T1). In particular, since the conversion ratio 320 changed to 1.35, the 10 staked crypto tokens (from acquisition date of T0) may now provide 7.40 wrapped staked crypto tokens but the previous principal income amount 310-a is 7.69 from which the second principal income amount 310-b is derived. As such, there has been a 0.29 gain in wrapped staked crypto token (e.g., difference between 7.69 principal income and 7.40 principal income of the wrapped staked crypto token) for the user. The cost basis for the second principal income amount 310-b may still be $8000 based on the acquisition date of T0, and thus, is not income (e.g., is income=false). Accordingly, the second reward amount 315-b is a rewards distribution of 0.29 of wrapped staked crypto tokens for the 10 staked crypto tokens at the third time period 305-c (from acquisition date of T2). The second reward amount 315-b may be considered income (e.g., is income=true) and may be subject to tax.

Additionally, at the third time period 305-c (T2) when the conversion rate changes from 1.3 to 1.35, the first reward amount 315-a may be split into the third principal income amount 310-c and the third reward amount 315-c based on the principal income and reward amount discussed with respect to the second time period 305-b (T1). Since the first reward amount 315-a is considered income and considered for tax purposes during the second time period 305-b (T1), the third principal income amount 310-c derived from the first reward amount 315-a may also be considered income (e.g., is income=true) and may be subjected to tax. However, the taxes are based on the acquisition date of T1 in order to not charge tax twice for the first reward amount 315-a).

Since the conversion ratio 320 changed from 1.3 to 1.35, the 0.31 rewards (from acquisition date of T1) may now provide 0.29 rewards in wrapped staked crypto tokens (e.g., ((0.30 rewards)*(1.3 conversion rate))/(1.35 conversion rate)) but the previous first reward amount 315-a is 0.31. As such, 0.29 rewards of the first reward amount 315-a may be considered as the third principal income amount 310-c, and the gain is 0.02. Thus, the third reward amount 315-c may be 0.02 wrapped staked crypto tokens and the third reward amount 315-c may be considered income for tax purposes (e.g., is income=true) but on the second acquisition date of T2. The cost basis for the third reward amount 315-c at the third time period 305-c (from acquisition date of T2) is $18.46. The cost basis for the third principal income amount 310-c of 0.29 wrapped staked crypto token from acquisition date of T1 is $400. The cost basis for the second reward amount 315-b of 0.29 wrapped staked crypto token from acquisition date of T2 is $461.54.

Over time (e.g., fourth time period (T4), fifth time period (T5), and so forth), the principal income amounts 310 and/or the reward amounts 315 may be split into additional principal income amounts 310 and/or additional reward amounts 315, such that they are compounded overtime. Tracking each occurrence of the principal income amount 310 and/or each occurrence of the reward amounts 315 at each of the time periods 305 may involve a great quantity of processing and computing power for computing resources. To facilitate efficient processing, the tracking algorithm may combine the multiple occurrences of each if the reward amounts 315, as indicated by the arrow. In some examples, the tracking algorithm may also combine multiple principal income amounts 310, for example, that have the same conversion ratio.

For example, the second reward amount 315-b of 0.29 and the third reward amount of 315-c of 0.02 may be combined into a single occurrence of a reward amount 315 as 0.31 in rewards at the third time period 305-c. By combining multiple reward amounts 315 at a time period 305, the computing resources may track a single occurrence of a reward amount 315 at each of the time periods 305 rather than a large or exponentially growing quantity of the reward amounts 315. Processing and tracking the single occurrence (e.g., at the blockchain ledger) may reduce latency and utilize relatively less power at the computing resources with respect to multiple occurrences of the principal income amounts 310 and/or the reward amounts 315, and thus, provide a more efficient technique for processing and tracking multiple principal income amounts 310 and/or the reward amounts 315.

At a third time period 305-d, the user may sell some of the staked crypto token. As such, the wrapped staked crypto token may be reverted back to the staked crypto token to facilitate selling. At the third time period 305-d, the conversion ratio 320 may remain unchanged with respect to the third time period 305-c, such that the conversion ratio 320 is still 1.35. The sale of the wrapped staked crypto token 340 may include a sale of 2.7 staked crypto tokens, resulting in the sale of 2.0 wrapped staked crypto tokens based on the conversion ratio of 1.35, and based on the principal income amounts 310 and reward amounts 315.

Selling the 2 wrapped staked crypto tokens may cost $2400 and the proceeds may be $3240, resulting in a realization of $840. In particular, the cost basis for 0.02 wrapped staked crypto token (from the third reward amount 315-c) may be approximately $18.46, the proceeds may be $18.46, and the realization may be $0.00. The cost basis for 0.29 wrapped staked crypto token (from the second reward amount 315-b) may be approximately $461.54, the proceeds may be $461.54, and the realization may be $0.00. The cost basis for 0.29 wrapped staked crypto token (from the third principal amount 310-c) may be approximately $400, the proceeds may be $480, and the realization may be $80.00. The cost basis for 1.41 wrapped staked crypto token (e.g., approximately 2−(0.02, 0.29, and 0.29)) may be approximately $1520, the proceeds may be $2280, and the realization may be $760.00. Thus, the 2 wrapped staked crypto tokens may be associated with a cost basis of $2400, proceeds of $3240, and a realization of $840.

In some examples, the wrapped staked crypto token may result in rewards based on an increase in conversion ratio between the wrapped staked crypto token and the staked crypto token without an increase in the balance of the wrapped staked crypto token. However, after a rewards distribution (e.g., return distribution) on the staked crypt token, the wrapped staked crypto token may be converted into relatively more staked crypto token than prior to the rewards distribution. For example, the amount of staked crypto token may be based on converting or unwrapping the wrapped staked crypto token balance during a time period 305, and determining how much of the unwrapped wrapped staked crypto token represents the principal income amount 310 and how much represents the reward amount 315.

The determination may be made using the following equations involving P, the amount of the wrapped staked crypto token, R, the conversion rate, T, the time, and I, the income lot. The initial amount may be P wrapped staked crypto token acquired at a conversion rate, R0, at an initial time, T0. After the first rewards distribution occurs at T1 with the conversion rate R1, the P amount may include P1=the amount converted into staked crypto token using R1, and returning the same value as P using R0=>P*R0=P1*RI=>P1=P*(R0/R1). The initial amount I1=amount which converted into staked crypto token using R1 conversion may return the amount of rewards yielded by the current rewards distribution of P=P1+I1=>I1=P−P*(R0/R1)=>I1=P*((R0−R1) R1).

At the second time period 305-b (T2), the conversion rate changes to R2. Accordingly, P2=P*(R0/R2). P=P2+(amount that converted using R2 to return the same amount as I1*R1)+I2. The P=P2+I1*(R1/R2)+I2=>I2=P−P*(R0/R2)−P*((R1−R0)/R1)*(R1/R2)=>I2=P*(1−(R0/R2)−(R1/R2)+(R0/R2))=>I2=P*((R2−R1)/R2). At the third time period 305-c (T3), the conversion rate changes to R3. Similarly, the P3=P*(R0/R3). The P=P3+ (amount that converted using R3 to return the same amount as I1*R1)+(amount that converted using R3 to return the same amount as I2*R2)+I3. The P=P3+I1*(R1/R3)+I2*(R2/R3)+I3=>I3=P−P*(R0/R3)−P*(R1−R0)/R1)*(R1/R3)−P*(R2−R1)/R2)*R2. The R3=>I3=P*(1−(R0/R3)−(R1/R3)+(R0/R3)−(R2/R3)+(R1/R3)=>I3=P*R3−R2/R3. Thus, at n time period, Tn, when the conversion rate changes to Rn=>Pn=P*(R0/Rn). The In=P*((Rn−Rₙ₋₁)/Rn).

In some examples, such as for tax calculations, the original amount of each income lot, I, may be used to calculate the cost basis and the remaining amount after each reward for lot matching. The following table describes how the principal and the yielded interest amounts may be calculated after each rewards distribution.

| #rewards | | | | | | |
|---|---|---|---|---|---|---|
| distributions | 0 | 1 | 2 | 3 | . . . | n |
| Amounts | P | $P * \frac{R 0}{R 1}$ | $P * \frac{R 0}{R 2}$ | $P * \frac{R 0}{R 3}$ | | $P * \frac{R 0}{Rn}$ |
| | i1 | $P * \frac{R 1 - R 0}{R 1}$ | $P * \frac{R 1 - R 0}{R 2}$ | $P * \frac{R 1 - R 0}{R 3}$ | | $P * \frac{R 1 - R 0}{Rn}$ |
| | i2 | | $P * \frac{R 2 - R 1}{R 2}$ | $P * \frac{R 2 - R 1}{R 3}$ | | $P * \frac{R 2 - R 1}{Rn}$ |
| | i3 | | | $P * \frac{R 3 - R 2}{R 3}$ | | $P * \frac{R 3 - R 2}{Rn}$ |
| | . | | | | | |
| | . | | | | | |
| | . | | | | | |
| | ik | | | | | $P * \frac{{R}_{k} - {R}_{k - 1}}{Rn}$ |

The sum of each column in the table may equal P. In some examples, such as for multiple principal income amounts 310, the multiple principal income lots may be organized by a commonality, such as grouped by a common conversion rate (e.g., after the first rewards distribution) using the following equation.

$${I}_{1} = ( 1 / {R}_{1} ) * ( ( Pa 1 + Pa 2 + Pa 3 + . ) * ( {R}_{1} - {R}_{a} ) + ( Pb 1 + Pb 2 + Pb 3 + . ) * ( {R}_{1} - {R}_{b} ) + . )$$

where Px1, Px2, . . . =principal lots acquired at conversion rate Rx and R1=the conversion rate after the first rewards distribution. Once the principal income amounts are adjusted to the same conversion rate, the following equation may be used to determine the amount of the income lot.

$${I}_{k} = ( Pa 1 + Pb 1 + Pa 2 + Pb 2 + . ) * ( ( {R}_{k} - {R}_{k - 1 ) /} {R}_{n} )$$

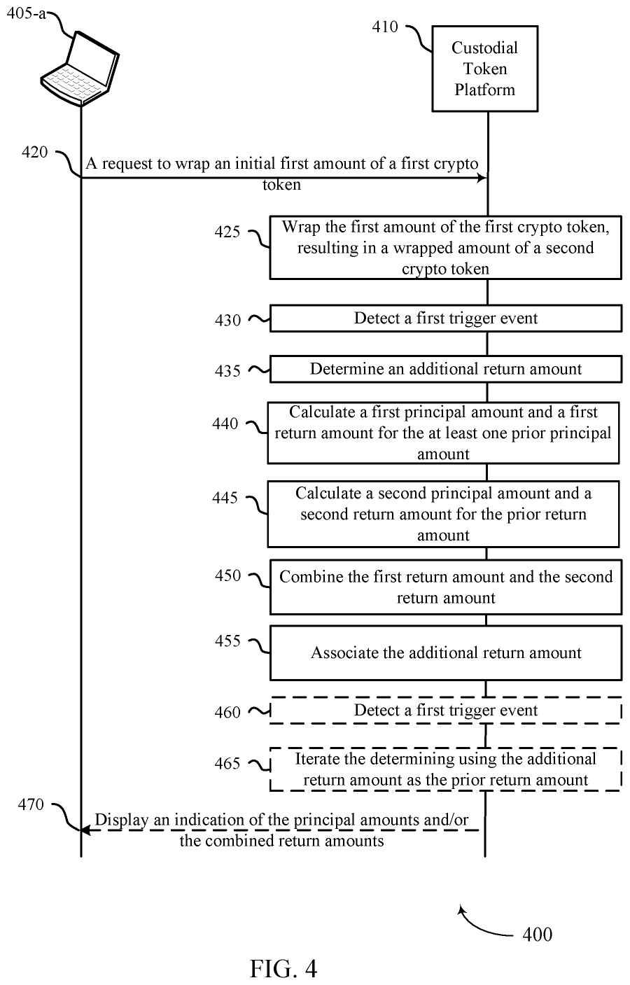

FIG. 4 shows an example of a process flow 400 that supports tracking staked token returns in accordance with aspects of the present disclosure. The process flow 400 includes a first user device 405-a and a custodial token platform 410, which may be examples of the corresponding devices or systems as described herein with respect to FIGS. 1 through 3 (e.g., user device 205-a and custodial token platform 210 of FIG. 2). In the following description of the process flow 400, the operations between the user device 405-a and the custodial token platform 410 may be transmitted in a different order than the example order shown, or the operations performed may be performed in different orders or at different times. Some operations may also be omitted from the process flow 400, and other operations may be added to the process flow 400.

At 420, the custodial token platform 410 may request, from the user device 405-a, a request to wrap an initial first amount of a first crypto token (e.g., ETH) that is staked in accordance with a protocol associated with a blockchain network supported distributed data store. At 425, the custodial token platform 410 may wrap, after receiving the request, the first amount of the first crypto token, the wrapping resulting in a wrapped amount of a second crypto token (e.g., wrapped staked ETH, cbETH) being associated with the user. In some examples, the second crypto token is transferable via the protocol associated with the blockchain network supported distributed data store. At 430, the custodial token platform 410 may detect a first trigger event (e.g., reward distribution) while the user is associated with at least one prior principal amount and a prior return amount of the second crypto token as a result of a prior trigger event. A trigger event may include a return distribution for the first crypto token as a result of staking the first crypto token via the protocol. At 435, the custodial token platform 410 may determine, in response to the first trigger event, an additional return amount.

At 440, the determining may include the custodial token platform 410 calculating, using an updated conversion ratio resulting from the return distribution, a first principal amount and a first return amount for the at least one prior principal amount. In some examples, the updated conversion ratio may be a conversion ratio that is updated based on a staking return or slashing penalty in accordance with staking via the protocol. In some examples, calculating the first principal amount as a first amount of the second crypto token that, if unwrapped using the updated conversion ratio, results in the single prior principal amount. In such examples, the custodial token platform 410 may determine the first return amount as a second amount of the second crypto token remaining after subtracting the first amount from the single prior principal amount.

At 445, the determining may include the custodial token platform 410 calculating, using the updated conversion ratio, a second principal amount and a second return amount for the prior return amount. In some examples, the custodial token platform 410 may calculate the second principal amount as a first amount of the second crypto token that, if unwrapped using the updated conversion ratio, resulting in the prior return amount. In such examples, the custodial token platform 410 may subtract the first amount from the prior return amount to obtain the second return amount.

At 450 the custodial token platform 410 may combine the first return amount and the second return amount as the additional return amount. At 455, the determining may include the custodial token platform 410 associating the additional return amount, the first principal amount, and the second principal amount with the user. In some examples, at 470, the custodial token platform 410 may display, at a user interface of the user device 405-a, an indication of one or more principal amounts, one or more combined return amounts, or a combination thereof.

In some examples, at 460, the custodial token platform 410 may detect one or more additional trigger events subsequent to the first event. In some examples, at 465 the custodial token platform 410 may iterate, for the one or more additional trigger events, the determining using the additional return amount as the prior return amount. Each time the custodial token platform 410 determines the additional return amount, it may be associated with the user account, and subsequent calculations may use the additional return amount as the prior return amount.

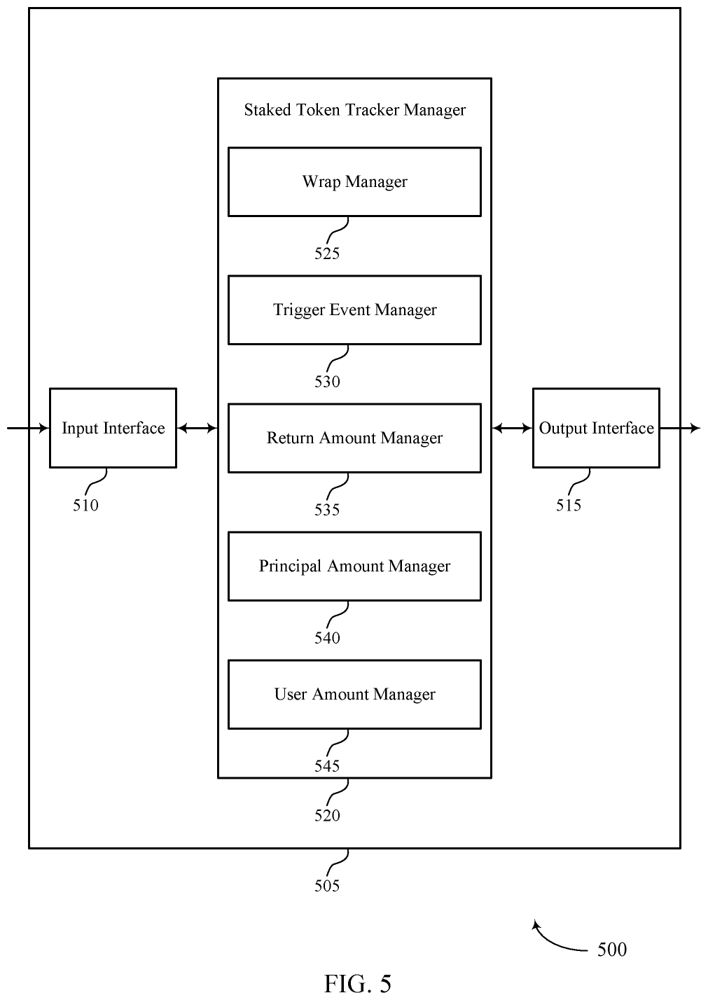

FIG. 5 shows a block diagram 500 of a system 505 that supports tracking staked token returns in accordance with aspects of the present disclosure. The system 505 may include an input interface 510, an output interface 515, and a staked token tracker manager 520. The system 505, or one or more components of the system 505 (e.g., the input interface 510, the output interface 515, and the staked token tracker manager 520), may include at least one processor, which may be coupled with at least one memory, to support the described techniques. Each of these components may communicate, directly or indirectly, with one another (e.g., via one or more buses, communications links, communications interfaces, or any combination thereof).

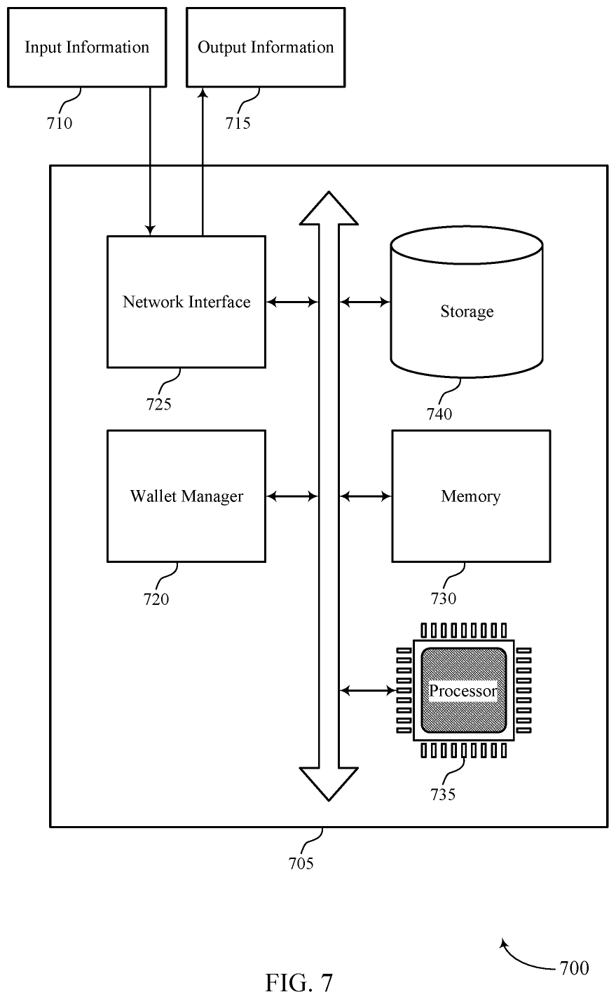

The input interface 510 may manage input signaling for the system 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the staked token tracker manager 520 to support tracking staked token returns. In some cases, the input interface 510 may be a component of a network interface 725 as described with reference to FIG. 7.

The output interface 515 may manage output signaling for the system 505. For example, the output interface 515 may receive signaling from other components of the system 505, such as the staked token tracker manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the staked token tracker manager 520 may include a wrap manager 525, a trigger event manager 530, a return amount manager 535, a principal amount manager 540, a user amount manager 545, or any combination thereof. In some examples, the staked token tracker manager 520, or various components thereof, may be configured to perform various operations (e.g., receiving, monitoring, transmitting) using or otherwise in cooperation with the input interface 510, the output interface 515, or both. For example, the staked token tracker manager 520 may receive information from the input interface 510, send information to the output interface 515, or be integrated in combination with the input interface 510, the output interface 515, or both to receive information, transmit information, or perform various other operations as described herein.

The staked token tracker manager 520 may support token management in accordance with examples as disclosed herein. The wrap manager 525 may be configured as or otherwise support a means for receiving, from a user, a request to wrap an initial first amount of a first crypto token that is staked in accordance with a protocol associated with a blockchain network supported distributed data store. The wrap manager 525 may be configured as or otherwise support a means for wrapping, after receiving the request, the first amount of the first crypto token, the wrapping resulting in a wrapped amount of a second crypto token being associated with the user. The trigger event manager 530 may be configured as or otherwise support a means for detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol. The return amount manager 535 may be configured as or otherwise support a means for determining, in response to the first trigger event, an additional return amount, the determining comprising. The principal amount manager 540 may be configured as or otherwise support a means for calculating, using an updated conversion ratio resulting from the return distribution, a first principal amount and a first return amount for the at least one prior principal amount. The principal amount manager 540 may be configured as or otherwise support a means for calculating, using the updated conversion ratio, a second principal amount and a second return amount for the prior return amount. The return amount manager 535 may be configured as or otherwise support a means for combining the first return amount and the second return amount as the additional return amount. The user amount manager 545 may be configured as or otherwise support a means for associating the additional return amount, the first principal amount, and the second principal amount with the user.

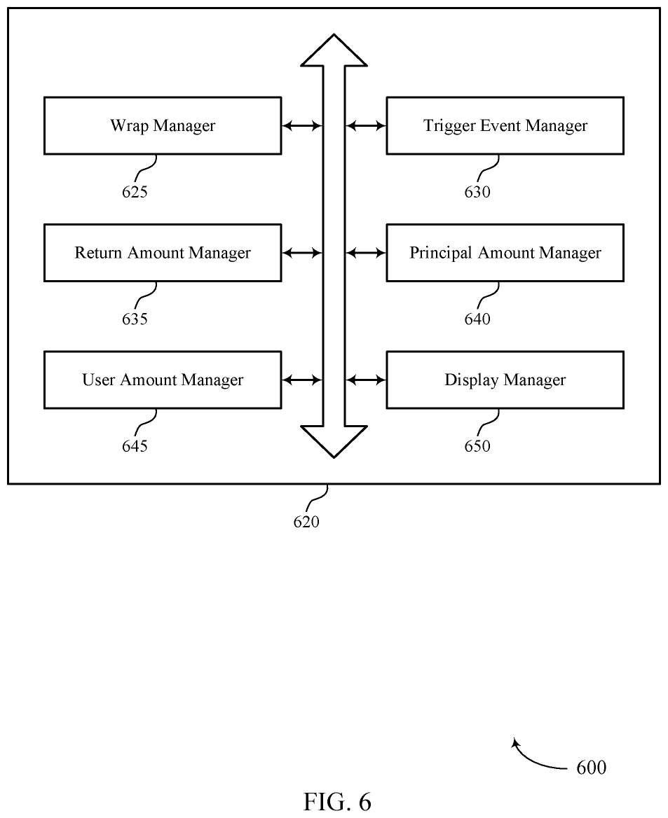

FIG. 6 shows a block diagram 600 of a staked token tracker manager 620) that supports tracking staked token returns in accordance with aspects of the present disclosure. The staked token tracker manager 620 may be an example of aspects of a staked token tracker manager 520 or one or more servers supporting a custodial token platform, as described herein. The staked token tracker manager 620, or various components thereof, may be an example of means for performing various aspects of tracking staked token as described herein. For example, the staked token tracker manager 620 may include a wrap manager 625, a trigger event manager 630, a return amount manager 635, a principal amount manager 640, a user amount manager 645, a display manager 650, or any combination thereof. Each of these components may communicate, directly or indirectly, with one another (e.g., via one or more buses, communications links, communications interfaces, or any combination thereof).

The staked token tracker manager 620 may support token management in accordance with examples as disclosed herein. The wrap manager 625 may be configured as or otherwise support a means for receiving, from a user, a request to wrap an initial first amount of a first crypto token that is staked in accordance with a protocol associated with a blockchain network supported distributed data store. In some examples, the wrap manager 625 may be configured as or otherwise support a means for wrapping, after receiving the request, the first amount of the first crypto token, the wrapping resulting in a wrapped amount of a second crypto token being associated with the user. The trigger event manager 630 may be configured as or otherwise support a means for detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol. The return amount manager 635 may be configured as or otherwise support a means for determining, in response to the first trigger event, an additional return amount, the determining comprising. The principal amount manager 640 may be configured as or otherwise support a means for calculating, using an updated conversion ratio resulting from the return distribution, a first principal amount and a first return amount for the at least one prior principal amount. In some examples, the principal amount manager 640 may be configured as or otherwise support a means for calculating, using the updated conversion ratio, a second principal amount and a second return amount for the prior return amount. In some examples, the return amount manager 635 may be configured as or otherwise support a means for combining the first return amount and the second return amount as the additional return amount. The user amount manager 645 may be configured as or otherwise support a means for associating the additional return amount, the first principal amount, and the second principal amount with the user.

In some examples, the trigger event manager 630 may be configured as or otherwise support a means for detecting one or more additional trigger events subsequent to the first event. In some examples, the return amount manager 635 may be configured as or otherwise support a means for iterating, for the one or more additional trigger events, the determining using the additional return amount as the prior return amount.

In some examples, to support calculating the first principal amount and the first return amount for a single prior principal amount, the principal amount manager 640 may be configured as or otherwise support a means for calculating the first principal amount as a first amount of the second crypto token that, if unwrapped using the updated conversion ratio, results in the single prior principal amount. In some examples, to support calculating the first principal amount and the first return amount for a single prior principal amount, the return amount manager 635 may be configured as or otherwise support a means for determining the first return amount as a second amount of the second crypto token remaining after subtracting the first amount from the single prior principal amount.

In some examples, to support calculating the second principal amount and second first return amount, the principal amount manager 640 may be configured as or otherwise support a means for calculating the second principal amount as a first amount of the second crypto token that, if unwrapped using the updated conversion ratio, results in the prior return amount. In some examples, to support calculating the second principal amount and second first return amount, the return amount manager 635 may be configured as or otherwise support a means for subtracting the first amount from the prior return amount to obtain the second return amount.

In some examples, the conversion ratio is updated based at least in part on a staking return or slashing penalty in accordance with staking via the protocol.

In some examples, the second crypto token is transferable via the protocol associated with the blockchain network supported distributed data store.

In some examples, the display manager 650 may be configured as or otherwise support a means for displaying, at a user interface, an indication of one or more principal amounts, one or more combined return amounts, or a combination thereof.

FIG. 7 shows a diagram 700 of a system 705 that supports tracking staked token returns in accordance with aspects of the present disclosure. The system 705 may be an example of or include the components of a system 505 as described herein. The system 705 may include components for supporting services implemented by a custodial token platform, such as a staked token tracker manager 720, an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof).

The network interface 725 may enable the system 705 to exchange information (e.g., input information 710, output information 715, or both) with other systems or devices (not shown). For example, the network interface 725 may enable the system 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting tracking staked token returns. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the system 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting tracking staked token). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. The processor 735 may be an example of a single processor or multiple processors. For example, the system 705 may include one or more processors 735.

Storage 740) may be configured to store data that is generated, processed, stored, or otherwise used by the system 705. In some cases, the storage 740) may include one or more HDDs, one or more SDDs, or both. In some examples, the storage 740) may be an example of a single database, a distributed database, multiple distributed databases, a data store, a data lake, or an emergency backup database. In some examples, the storage 740 may be an example of one or more components described with reference to FIG. 1, such as one or more network disks.

The staked token tracker manager 720) may support token management in accordance with examples as disclosed herein. For example, the staked token tracker manager 720) may be configured as or otherwise support a means for receiving, from a user, a request to wrap an initial first amount of a first crypto token that is staked in accordance with a protocol associated with a blockchain network supported distributed data store. The staked token tracker manager 720 may be configured as or otherwise support a means for wrapping, after receiving the request, the first amount of the first crypto token, the wrapping resulting in a wrapped amount of a second crypto token being associated with the user. The staked token tracker manager 720) may be configured as or otherwise support a means for detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol. The staked token tracker manager 720 may be configured as or otherwise support a means for determining, in response to the first trigger event, an additional return amount, the determining comprising. The staked token tracker manager 720 may be configured as or otherwise support a means for calculating, using an updated conversion ratio resulting from the return distribution, a first principal amount and a first return amount for the at least one prior principal amount. The staked token tracker manager 720 may be configured as or otherwise support a means for calculating, using the updated conversion ratio, a second principal amount and a second return amount for the prior return amount. The staked token tracker manager 720 may be configured as or otherwise support a means for combining the first return amount and the second return amount as the additional return amount. The staked token tracker manager 720 may be configured as or otherwise support a means for associating the additional return amount, the first principal amount, and the second principal amount with the user.

By including or configuring the staked token tracker manager 720 in accordance with examples as described herein, the system 705 may support techniques for tracking staked crypto token with reduced latency, reduced power consumption, and an overall more efficient utilization of computational resources by combining principal income amounts and/or reward amounts at one or more time periods over time, where the multiple principal income amounts and/or reward amounts (e.g., large quantity that increases exponentially or compounding over time) may otherwise be individually tracked over time.

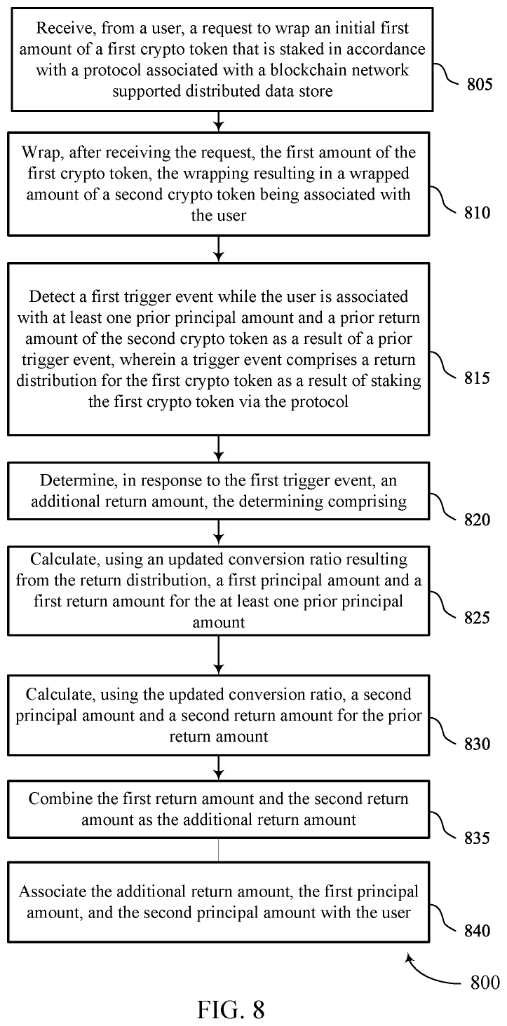

FIG. 8 shows a flowchart illustrating a method 800 that supports tracking staked token returns in accordance with aspects of the present disclosure. The operations of the method 800 may be implemented by a custodial token platform or its components as described herein. For example, the operations of the method 800 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 805, the method may include receiving, from a user, a request to wrap an initial first amount of a first crypto token that is staked in accordance with a protocol associated with a blockchain network supported distributed data store. The operations of block 805 may be performed in accordance with examples as disclosed herein. In some examples, aspects of the operations of 805 may be performed by a wrap manager 625 as described with reference to FIG. 6.

At 810, the method may include wrapping, after receiving the request, the first amount of the first crypto token, the wrapping resulting in a wrapped amount of a second crypto token being associated with the user. The operations of block 810 may be performed in accordance with examples as disclosed herein. In some examples, aspects of the operations of 810 may be performed by a wrap manager 625 as described with reference to FIG. 6.

At 815, the method may include detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol. The operations of block 815 may be performed in accordance with examples as disclosed herein. In some examples, aspects of the operations of 815 may be performed by a trigger event manager 630 as described with reference to FIG. 6.

At 820, the method may include determining, in response to the first trigger event, an additional return amount, the determining comprising. The operations of block 820 may be performed in accordance with examples as disclosed herein. In some examples, aspects of the operations of 820 may be performed by a return amount manager 635 as described with reference to FIG. 6.

At 825, the method may include calculating, using an updated conversion ratio resulting from the return distribution, a first principal amount and a first return amount for the at least one prior principal amount. The operations of block 825 may be performed in accordance with examples as disclosed herein. In some examples, aspects of the operations of 825 may be performed by a principal amount manager 640 as described with reference to FIG. 6.

At 830, the method may include calculating, using the updated conversion ratio, a second principal amount and a second return amount for the prior return amount. The operations of block 830 may be performed in accordance with examples as disclosed herein. In some examples, aspects of the operations of 830 may be performed by a principal amount manager 640 as described with reference to FIG. 6.

At 835, the method may include combining the first return amount and the second return amount as the additional return amount. The operations of block 835 may be performed in accordance with examples as disclosed herein. In some examples, aspects of the operations of 835 may be performed by a return amount manager 635 as described with reference to FIG. 6.

At 840, the method may include associating the additional return amount, the first principal amount, and the second principal amount with the user. The operations of block 840 may be performed in accordance with examples as disclosed herein. In some examples, aspects of the operations of 840 may be performed by a user amount manager 645 as described with reference to FIG. 6.

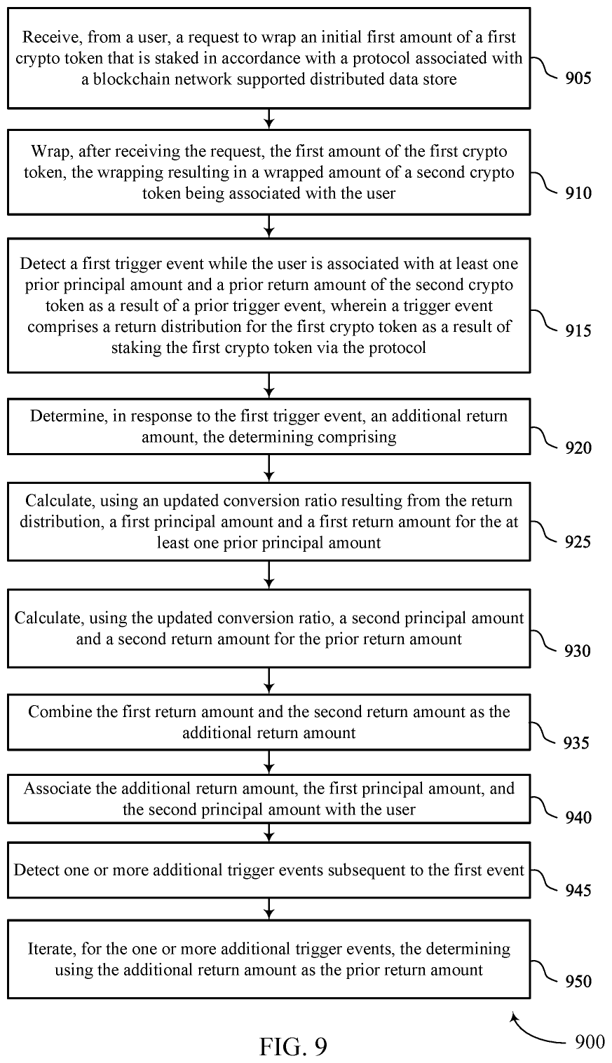

FIG. 9 shows a flowchart illustrating a method 900 that supports tracking staked token returns in accordance with aspects of the present disclosure. The operations of the method 900 may be implemented by a custodial token platform or its components as described herein. For example, the operations of the method 900 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 905, the method may include receiving, from a user, a request to wrap an initial first amount of a first crypto token that is staked in accordance with a protocol associated with a blockchain network supported distributed data store. The operations of block 905 may be performed in accordance with examples as disclosed herein. In some examples, aspects of the operations of 905 may be performed by a wrap manager 625 as described with reference to FIG. 6.

At 910, the method may include wrapping, after receiving the request, the first amount of the first crypto token, the wrapping resulting in a wrapped amount of a second crypto token being associated with the user. The operations of block 910 may be performed in accordance with examples as disclosed herein. In some examples, aspects of the operations of 910 may be performed by a wrap manager 625 as described with reference to FIG. 6.

At 915, the method may include detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol. The operations of block 915 may be performed in accordance with examples as disclosed herein. In some examples, aspects of the operations of 915 may be performed by a trigger event manager 630 as described with reference to FIG. 6.

At 920, the method may include determining, in response to the first trigger event, an additional return amount, the determining comprising. The operations of block 920 may be performed in accordance with examples as disclosed herein. In some examples, aspects of the operations of 920 may be performed by a return amount manager 635 as described with reference to FIG. 6.

At 925, the method may include calculating, using an updated conversion ratio resulting from the return distribution, a first principal amount and a first return amount for the at least one prior principal amount. The operations of block 925 may be performed in accordance with examples as disclosed herein. In some examples, aspects of the operations of 925 may be performed by a principal amount manager 640 as described with reference to FIG. 6.

At 930, the method may include calculating, using the updated conversion ratio, a second principal amount and a second return amount for the prior return amount. The operations of block 930 may be performed in accordance with examples as disclosed herein. In some examples, aspects of the operations of 930 may be performed by a principal amount manager 640 as described with reference to FIG. 6.

At 935, the method may include combining the first return amount and the second return amount as the additional return amount. The operations of block 935 may be performed in accordance with examples as disclosed herein. In some examples, aspects of the operations of 935 may be performed by a return amount manager 635 as described with reference to FIG. 6.

At 940, the method may include associating the additional return amount, the first principal amount, and the second principal amount with the user. The operations of block 940 may be performed in accordance with examples as disclosed herein. In some examples, aspects of the operations of 940 may be performed by a user amount manager 645 as described with reference to FIG. 6.

At 945, the method may include detecting one or more additional trigger events subsequent to the first event. The operations of block 945 may be performed in accordance with examples as disclosed herein. In some examples, aspects of the operations of 945 may be performed by a trigger event manager 630 as described with reference to FIG. 6.

At 950, the method may include iterating, for the one or more additional trigger events, the determining using the additional return amount as the prior return amount. The operations of block 950 may be performed in accordance with examples as disclosed herein. In some examples, aspects of the operations of 950 may be performed by a return amount manager 635 as described with reference to FIG. 6.

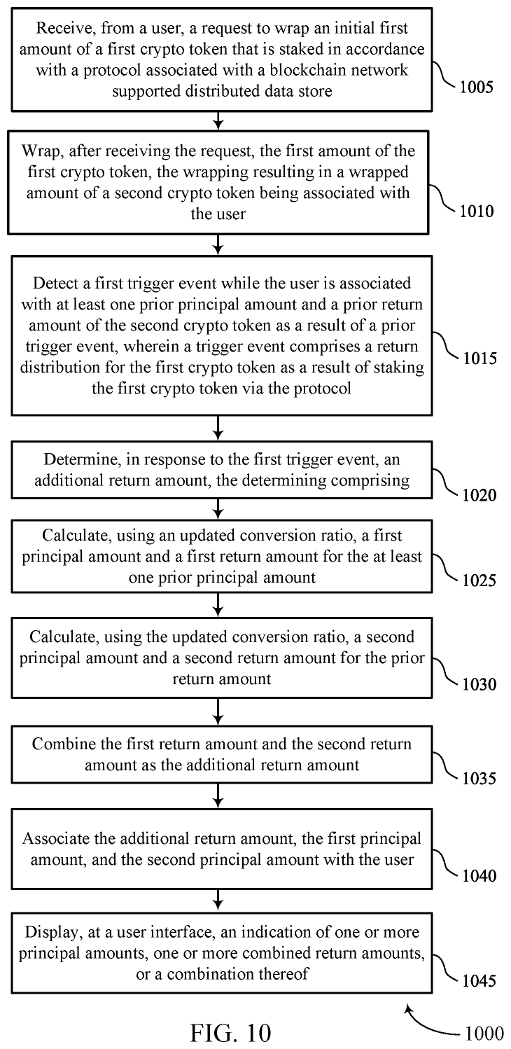

FIG. 10 shows a flowchart illustrating a method 1000 that supports tracking staked token returns in accordance with aspects of the present disclosure. The operations of the method 1000 may be implemented by a custodial token platform or its components as described herein. For example, the operations of the method 1000 may be performed by a custodial token platform as described with reference to FIGS. 1 through 7. In some examples, a custodial token platform may execute a set of instructions to control the functional elements of the custodial token platform to perform the described functions. Additionally, or alternatively, the custodial token platform may perform aspects of the described functions using special-purpose hardware.

At 1005, the method may include receiving, from a user, a request to wrap an initial first amount of a first crypto token that is staked in accordance with a protocol associated with a blockchain network supported distributed data store. The operations of block 1005 may be performed in accordance with examples as disclosed herein. In some examples, aspects of the operations of 1005 may be performed by a wrap manager 625 as described with reference to FIG. 6.

At 1010, the method may include wrapping, after receiving the request, the first amount of the first crypto token, the wrapping resulting in a wrapped amount of a second crypto token being associated with the user. The operations of block 1010 may be performed in accordance with examples as disclosed herein. In some examples, aspects of the operations of 1010 may be performed by a wrap manager 625 as described with reference to FIG. 6.

At 1015, the method may include detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol. The operations of block 1015 may be performed in accordance with examples as disclosed herein. In some examples, aspects of the operations of 1015 may be performed by a trigger event manager 630 as described with reference to FIG. 6.

At 1020, the method may include determining, in response to the first trigger event, an additional return amount, the determining comprising. The operations of block 1020 may be performed in accordance with examples as disclosed herein. In some examples, aspects of the operations of 1020 may be performed by a return amount manager 635 as described with reference to FIG. 6.

At 1025, the method may include calculating, using an updated conversion ratio resulting from the return distribution, a first principal amount and a first return amount for the at least one prior principal amount. The operations of block 1025 may be performed in accordance with examples as disclosed herein. In some examples, aspects of the operations of 1025 may be performed by a principal amount manager 640 as described with reference to FIG. 6.

At 1030, the method may include calculating, using the updated conversion ratio, a second principal amount and a second return amount for the prior return amount. The operations of block 1030 may be performed in accordance with examples as disclosed herein. In some examples, aspects of the operations of 1030 may be performed by a principal amount manager 640 as described with reference to FIG. 6.

At 1035, the method may include combining the first return amount and the second return amount as the additional return amount. The operations of block 1035 may be performed in accordance with examples as disclosed herein. In some examples, aspects of the operations of 1035 may be performed by a return amount manager 635 as described with reference to FIG. 6.

At 1040, the method may include associating the additional return amount, the first principal amount, and the second principal amount with the user. The operations of block 1040 may be performed in accordance with examples as disclosed herein. In some examples, aspects of the operations of 1040 may be performed by a user amount manager 645 as described with reference to FIG. 6.

At 1045, the method may include displaying, at a user interface, an indication of one or more principal amounts, one or more combined return amounts, or a combination thereof. The operations of block 1045 may be performed in accordance with examples as disclosed herein. In some examples, aspects of the operations of 1045 may be performed by a display manager 650 as described with reference to FIG. 6.

A method for token management by an apparatus is described. The method may include receiving, from a user, a request to wrap an initial first amount of a first crypto token that is staked in accordance with a protocol associated with a blockchain network supported distributed data store, wrapping, after receiving the request, the first amount of the first crypto token, the wrapping resulting in a wrapped amount of a second crypto token being associated with the user, detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol, determining, in response to the first trigger event, an additional return amount, the determining comprising, calculating, using an updated conversion ratio resulting from the return distribution, a first principal amount and a first return amount for the at least one prior principal amount, calculating, using the updated conversion ratio, a second principal amount and a second return amount for the prior return amount, combining the first return amount and the second return amount as the additional return amount, and associating the additional return amount, the first principal amount, and the second principal amount with the user.

An apparatus for token management is described. The apparatus may include one or more memories storing processor executable code, and one or more processors coupled with the one or more memories. The one or more processors may individually or collectively operable to execute the code to cause the apparatus to receive, from a user, a request to wrap an initial first amount of a first crypto token that is staked in accordance with a protocol associated with a blockchain network supported distributed data store, wrapping, after receiving the request, the first amount of the first crypto token, the wrapping resulting in a wrapped amount of a second crypto token being associated with the user, detect a first trigger event while the user is associated with at least one prior principal amount and a prior return amount of the second crypto token as a result of a prior trigger event, wherein a trigger event comprises a return distribution for the first crypto token as a result of staking the first crypto token via the protocol, determine, in response to the first trigger event, an additional return amount, the determining comprising, calculate, using an updated conversion ratio resulting from the return distribution, a first principal amount and a first return amount for the at least one prior principal amount, calculate, using the updated conversion ratio, a second principal amount and a second return amount for the prior return amount, combine the first return amount and the second return amount as the additional return amount, and associate the additional return amount, the first principal amount, and the second principal amount with the user.

Another apparatus for token management is described. The apparatus may include means for receiving, from a user, a request to wrap an initial first amount of a first crypto token that is staked in accordance with a protocol associated with a blockchain network supported distributed data store, means for wrapping, after receiving the request, the first amount of the first crypto token, the wrapping resulting in a wrapped amount of a second crypto token being associated with the user, means for detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol, means for determining, in response to the first trigger event, an additional return amount, the determining comprising, means for calculating, using an updated conversion ratio resulting from the return distribution, a first principal amount and a first return amount for the at least one prior principal amount, means for calculating, using the updated conversion ratio, a second principal amount and a second return amount for the prior return amount, means for combining the first return amount and the second return amount as the additional return amount, and means for associating the additional return amount, the first principal amount, and the second principal amount with the user.

A non-transitory computer-readable medium storing code for token management is described. The code may include instructions executable by a processor to receive, from a user, a request to wrap an initial first amount of a first crypto token that is staked in accordance with a protocol associated with a blockchain network supported distributed data store, wrapping, after receiving the request, the first amount of the first crypto token, the wrapping resulting in a wrapped amount of a second crypto token being associated with the user, detect a first trigger event while the user is associated with at least one prior principal amount and a prior return amount of the second crypto token as a result of a prior trigger event, wherein a trigger event comprises a return distribution for the first crypto token as a result of staking the first crypto token via the protocol, determine, in response to the first trigger event, an additional return amount, the determining comprising, calculate, using an updated conversion ratio resulting from the return distribution, a first principal amount and a first return amount for the at least one prior principal amount, calculate, using the updated conversion ratio, a second principal amount and a second return amount for the prior return amount, combine the first return amount and the second return amount as the additional return amount, and associate the additional return amount, the first principal amount, and the second principal amount with the user.

Some examples of the method, apparatus, and non-transitory computer-readable medium described herein may further include operations, features, means, or instructions for detecting one or more additional trigger events subsequent to the first event and iterating, for the one or more additional trigger events, the determining using the additional return amount as the prior return amount.

In some examples of the method, apparatus, and non-transitory computer-readable medium described herein, calculating the first principal amount and the first return amount for a single prior principal amount may include operations, features, means, or instructions for calculating the first principal amount as a first amount of the second crypto token that, if unwrapped using the updated conversion ratio, results in the single prior principal amount and determining the first return amount as a second amount of the second crypto token remaining after subtracting the first amount from the single prior principal amount.

In some examples of the method, apparatus, and non-transitory computer-readable medium described herein, calculating the second principal amount and second first return amount may include operations, features, means, or instructions for calculating the second principal amount as a first amount of the second crypto token that, if unwrapped using the updated conversion ratio, results in the prior return amount and subtracting the first amount from the prior return amount to obtain the second return amount.

In some examples of the method, apparatus, and non-transitory computer-readable medium described herein, the conversion ratio may be updated based at least in part on a staking return or slashing penalty in accordance with staking via the protocol.

In some examples of the method, apparatus, and non-transitory computer-readable medium described herein, the second crypto token may be transferable via the protocol associated with the blockchain network supported distributed data store.

Some examples of the method, apparatus, and non-transitory computer-readable medium described herein may further include operations, features, means, or instructions for displaying, at a user interface, an indication of one or more principal amounts, one or more combined return amounts, or a combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for token management, comprising:
receiving, from a user, a request to wrap an initial first amount of a first crypto token that is staked in accordance with a protocol associated with a blockchain network supported distributed data store;
wrapping, after receiving the request, the first amount of the first crypto token, the wrapping resulting in a wrapped amount of a second crypto token being associated with the user;
detecting a first trigger event while the user is associated with at least one prior principal amount and a prior return amount of the second crypto token as a result of a prior trigger event, wherein a trigger event comprises a return distribution for the first crypto token as a result of staking the first crypto token via the protocol;
determining, in response to the first trigger event, an additional return amount, the determining comprising:
calculating, using an updated conversion ratio resulting from the return distribution, a first principal amount and a first return amount for the at least one prior principal amount,
calculating, using the updated conversion ratio, a second principal amount and a second return amount for the prior return amount, and
combining the first return amount and the second return amount as the additional return amount; and
associating the additional return amount, the first principal amount, and the second principal amount with the user.

2. The method of claim 1, further comprising:
detecting one or more additional trigger events subsequent to the first trigger event; and
iterating, for the one or more additional trigger events, the determining using the additional return amount as the prior return amount.

3. The method of claim 1, wherein calculating the first principal amount and the first return amount for a single prior principal amount comprises:
calculating the first principal amount as a first amount of the second crypto token that, if unwrapped using the updated conversion ratio, results in the single prior principal amount; and
determining the first return amount as a second amount of the second crypto token remaining after subtracting the first amount from the single prior principal amount.

4. The method of claim 1, wherein calculating the second principal amount and second first return amount comprises:
calculating the second principal amount as a first amount of the second crypto token that, if unwrapped using the updated conversion ratio, results in the prior return amount; and
subtracting the first amount from the prior return amount to obtain the second return amount.

5. The method of claim 1, wherein the updated conversion ratio is updated based at least in part on a staking return or slashing penalty in accordance with staking via the protocol.

6. The method of claim 1, wherein the second crypto token is transferable via the protocol associated with the blockchain network supported distributed data store.

7. The method of claim 1, further comprising:
displaying, at a user interface, an indication of one or more principal amounts, one or more combined return amounts, or a combination thereof.

8. An apparatus for token management, comprising:
one or more memories storing processor-executable code; and
one or more processors coupled with the one or more memories and individually or collectively operable to execute the code to cause the apparatus to:
receive, from a user, a request to wrap an initial first amount of a first crypto token that is staked in accordance with a protocol associated with a blockchain network supported distributed data store;
wrap, after receiving the request, the first amount of the first crypto token, the wrapping resulting in a wrapped amount of a second crypto token being associated with the user;
detect a first trigger event while the user is associated with at least one prior principal amount and a prior return amount of the second crypto token as a result of a prior trigger event, wherein a trigger event comprises a return distribution for the first crypto token as a result of staking the first crypto token via the protocol;
determine, in response to the first trigger event, an additional return amount, the determining comprising:
calculating, using an updated conversion ratio resulting from the return distribution, a first principal amount and a first return amount for the at least one prior principal amount,
calculating, using the updated conversion ratio, a second principal amount and a second return amount for the prior return amount, and
combining the first return amount and the second return amount as the additional return amount; and
associate the additional return amount, the first principal amount, and the second principal amount with the user.

9. The apparatus of claim 8, wherein the one or more processors are individually or collectively further operable to execute the code to cause the apparatus to:
detect one or more additional trigger events subsequent to the first trigger event; and
iterate, for the one or more additional trigger events, the determining using the additional return amount as the prior return amount.

10. The apparatus of claim 8, wherein, to calculate the first principal amount and the first return amount for a single prior principal amount, the one or more processors are individually or collectively operable to execute the code to cause the apparatus to:
calculate the first principal amount as a first amount of the second crypto token that, if unwrapped using the updated conversion ratio, results in the single prior principal amount; and
determine the first return amount as a second amount of the second crypto token remaining after subtracting the first amount from the single prior principal amount.

11. The apparatus of claim 8, wherein, to calculate the second principal amount and second first return amount, the one or more processors are individually or collectively operable to execute the code to cause the apparatus to:
calculate the second principal amount as a first amount of the second crypto token that, if unwrapped using the updated conversion ratio, results in the prior return amount; and
subtract the first amount from the prior return amount to obtain the second return amount.

12. The apparatus of claim 8, wherein the updated conversion ratio is updated based at least in part on a staking return or slashing penalty in accordance with staking via the protocol.

13. The apparatus of claim 8, wherein the second crypto token is transferable via the protocol associated with the blockchain network supported distributed data store.

14. The apparatus of claim 8, wherein the one or more processors are individually or collectively further operable to execute the code to cause the apparatus to:
display, at a user interface, an indication of one or more principal amounts, one or more combined return amounts, or a combination thereof.

15. A non-transitory computer-readable medium storing code for token management, the code comprising instructions executable by one or more processors to:
receive, from a user, a request to wrap an initial first amount of a first crypto token that is staked in accordance with a protocol associated with a blockchain network supported distributed data store;
wrap, after receiving the request, the first amount of the first crypto token, the wrapping resulting in a wrapped amount of a second crypto token being associated with the user;
detect a first trigger event while the user is associated with at least one prior principal amount and a prior return amount of the second crypto token as a result of a prior trigger event, wherein a trigger event comprises a return distribution for the first crypto token as a result of staking the first crypto token via the protocol;
determine, in response to the first trigger event, an additional return amount, the determining comprising:
calculating, using an updated conversion ratio resulting from the return distribution, a first principal amount and a first return amount for the at least one prior principal amount,
calculating, using the updated conversion ratio, a second principal amount and a second return amount for the prior return amount, and
combining the first return amount and the second return amount as the additional return amount; and
associate the additional return amount, the first principal amount, and the second principal amount with the user.

16. The non-transitory computer-readable medium of claim 15, wherein the instructions are further executable by the one or more processors to:
detect one or more additional trigger events subsequent to the first trigger event; and
iterate, for the one or more additional trigger events, the determining using the additional return amount as the prior return amount.

17. The non-transitory computer-readable medium of claim 15, wherein the instructions to calculate the first principal amount and the first return amount for a single prior principal amount are executable by the one or more processors to:
calculate the first principal amount as a first amount of the second crypto token that, if unwrapped using the updated conversion ratio, results in the single prior principal amount; and
determine the first return amount as a second amount of the second crypto token remaining after subtracting the first amount from the single prior principal amount.

18. The non-transitory computer-readable medium of claim 15, wherein the instructions to calculate the second principal amount and second first return amount are executable by the one or more processors to:
calculate the second principal amount as a first amount of the second crypto token that, if unwrapped using the updated conversion ratio, results in the prior return amount; and
subtract the first amount from the prior return amount to obtain the second return amount.

19. The non-transitory computer-readable medium of claim 15, wherein the updated conversion ratio is updated based at least in part on a staking return or slashing penalty in accordance with staking via the protocol.

20. The non-transitory computer-readable medium of claim 15, wherein the second crypto token is transferable via the protocol associated with the blockchain network supported distributed data store.
